(19) United States
(12) Patent Application Publication
(10) Pub. No.: US 2026/0087069 A1
(43) Pub. Date: Mar. 26, 2026

(54) SEARCH IN RESPONSE TO SELECTION OF VISUAL CONTENT

(71) Applicant: GOOGLE LLC, Mountain View, CA (US)

(72) Inventors: Katherine Faith Erdman, Mountain View, CA (US); Julia Rose Reichel, New York, NY (US); Xingyue Chen, Mountain View, CA (US); Chang Gao, New York, NY (US); Lucy Abramyan, Los Gatos, CA (US); Tuan Anh Nguyen, San Jose, CA (US); Connie Wenya Huang, Laguna Hills, CA (US); Daniel Snyder, Sunnyvale, CA (US); Ethan Owusu, Oakland, CA (US); Mariia Koliadenko, London (GB); Yipeng Yun, Redmond, WA (US); Brian Collins, South San Francisco, CA (US); Joost Korngold, Morgan Hill, CA (US); Steven Soon Leong Toh, Alameda, CA (US); Michael Christopher Yu, Mountain View, CA (US)

(21) Appl. No.: 19/342,330

(22) Filed: Sep. 26, 2025

Related U.S. Application Data
(60) Provisional application No. 63/699,459, filed on Sep. 26, 2024.

(51) Int. Cl. G06F 16/532; G06F 21/62; G06T 3/40; G06T 19/20

(52) U.S. Cl. CPC G06F 16/532; G06T 3/40; G06T 19/20; G06F 21/6245

(57) ABSTRACT

A method includes identifying a target within a three-dimensional scene based on input from a user, generating a two-dimensional image based on the target, determining that a query based on the two-dimensional image is to be performed, and performing the query based on the two-dimensional image.

### CROSS-REFERENCE TO RELATED APPLICATION

This application claims priority to U.S. Provisional Patent Application No. 63/699,459, filed on Sep. 26, 2024, entitled “SEARCH IN RESPONSE TO SELECTION OF VISUAL CONTENT”, the disclosure of which is incorporated by reference herein in its entirety.

### BACKGROUND

Users of eXtended Reality (XR) devices, which can include virtual reality (VR), augmented reality (AR), and/or mixed reality (MR), may desire to learn information about objects presented to them in an XR environment presented by the XR device.

### SUMMARY

Implementations enable a user to select a target presented by an XR device without typing a textual query. The target can include a virtual object generated by the XR device, a physical object that is present outside the XR environment, text, or a display element, and/or a screenshot that includes the virtual object, physical object, text, or display element, as non-limiting examples. The XR device can determine the target selected by the user based on a gaze of the user, based on motion of a hand or finger of the user, or based on a combination of the gaze and motion of the hand or finger. In some examples, the XR device generates a two-dimensional image based on the target, one or more camera images that capture the physical environment, and augmented reality content generated by the XR device. The XR device can send the selected target to another computing device (such as a server), such as by initiating a search based on the selected target, and receive information about the selected target from the computing device. The XR device can present the information about the selected target to the user.

According to an example, a method includes identifying a target within a three-dimensional scene based on input from a user, generating a two-dimensional image based on the target, determining that a query based on the two-dimensional image is to be performed, and performing the query based on the two-dimensional image.

According to an example, a non-transitory computer-readable storage medium comprises instructions stored. When executed by at least one processor, the are configured to cause a computing system to identify a target within a three-dimensional scene based on input from a user generate a two-dimensional image based on the target determine that a query based on the two-dimensional image is to be performed, and perform the query based on the two-dimensional image.

According to an example, a computing system includes at least one processor and a non-transitory computer-readable storage medium comprising instructions stored thereon. When executed by the at least one processor, the instructions are configured to cause the computing system to identify a target within a three-dimensional scene based on input from a user, generate a two-dimensional image based on the target, determine that a query based on the two-dimensional image is to be performed, and perform the query based on the two-dimensional image.

The details of one or more implementations are set forth in the accompanying drawings and the description below. Other features will be apparent from the description and drawings, and from the claims.

### BRIEF DESCRIPTION OF THE DRAWINGS

FIG. 1A shows an object presented to a user within an eXtended Reality (XR) environment.

FIG. 1B shows a selection of the object presented in FIG. 1A.

FIG. 2A shows a user selecting a target by movement of a hand of the user.

FIG. 2B shows a display presenting a selection by a user.

FIG. 3 shows a presentation of search results in response to selection of a target.

FIG. 4A shows selection of a query icon.

FIG. 4B shows a prompt to request a query.

FIG. 4C shows an image with a target for selection.

FIG. 4D shows an image with a query.

FIG. 4E shows a response to the query of FIG. 4D.

FIGS. 5A, 5B, and 5C show an example of a wearable device.

FIG. 6 is a flowchart of an example method performed in accordance with disclosed implementations.

Like reference numbers refer to like elements.

### DETAILED DESCRIPTION

Users of eXtended Reality (XR) devices, which can include virtual reality (VR), augmented reality (AR), and/or mixed reality (MR), may desire to learn information about virtual objects, text, or display elements presented to them in an XR environment presented by the XR device, or may desire to learn more about physical objects (which may include text) seen via the XR environment. The user can select a virtual object, a physical object, text, or a display element as a target to learn more information about. Thus, the virtual objects, text, display elements, and physical objects are referred to collectively as targets or potential targets. A target can be considered a physical object or virtual object within a field of view of a user within an extended reality environment, selected by the user to be the subject of a query for obtaining additional information. A technical problem with learning information about potential targets in an eXtended Reality environment involves the inherent ambiguity and querying of potential targets in a three-dimensional scene. Unlike traditional two-dimensional interfaces, a 3D XR scene presents multiple objects at varying depths, complicating the determination of a user's intended focus. Inputting text describing the targets can be difficult for a user in such an environment and the user may also be unsure how to describe the targets. As another example, a user may not have access to or may be unwilling to use additional input devices, such as a mobile device with a keyboard, a virtual keyboard, or pointer, or may not desire to provide voice input. A further technical challenge is the computational difficulty of translating a user's selection within this 3D space into a coherent two-dimensional image suitable for a visual search query.

At least one technical solution is for the XR device to support a mode where the XR device selects a target (e.g., a virtual object, physical object, display element, and/or text) within the three-dimensional environment for a query. The selected target can be presented by the XR device to the user or can be a physical object visible to the user within the XR environment. In some examples, the XR device can select the target based on a gaze of the user toward the target. In some examples, the XR device can select the target based on hand and/or finger movement around a location associated with the target. The XR device may resolve target selection ambiguity in a three-dimensional (3D) scene by generating a two-dimensional (2D) representation for a query. For example, to address issues with depth in the three-dimensional environment, implementations may capture a screenshot as a two-dimensional image of a portion of the field of view of the user that corresponds with the target and align the two-dimensional image (or screenshot) with the XR environment. Specifically, to overcome the technical problem of accurately identifying a user's intended target amongst objects at varying depths, the XR device casts a plurality of rays from the user's viewpoint to the objects within a target area. The device then identifies a shortest ray, which corresponds to the object closest to the user, establishing a reference depth. Based on this reference depth, the XR device generates a 2D image plane. This process translates the user's selection within the 3D space into a precise 2D image that is algorithmically aligned with the XR environment at the calculated depth. This 2D image, which can optionally be combined with textual data from user voice input, forms the basis of a data request sent to a search service. This method provides a concrete improvement to the functioning of the computer system itself by creating a more efficient and accurate human-machine interface for XR environments. The interface functionality is enhanced by reducing the computational ambiguity of 3D selections and streamlining the process of initiating a visual search query, thereby improving operational efficiency without requiring additional input peripherals. Implementations may then identify the target in the screenshot (the two-dimensional image). The XR device can perform a query on the selected target. A query can be a data request generated by an extended reality device for submission to a search service. The query and/or request can include a two-dimensional image representing the target. The query and/or text can also include textual data, such as textual data derived from voice input of the user. In some examples, the XR device performs the query on the selected target by sending the two-dimensional image (e.g. screenshot) to a computing device (such as a server) as part of a query, and receives a response to the query. The XR device can present the response to the query to the user. A technical benefit to this technical solution is accuracy in determining a target of the query without the use of additional input devices (e.g., a keyboard (virtual or physical), pointer, etc.). Thus, implementations improve human-machine interfaces by enabling the user to interact with the XR device in a more natural manner and with fewer inputs.

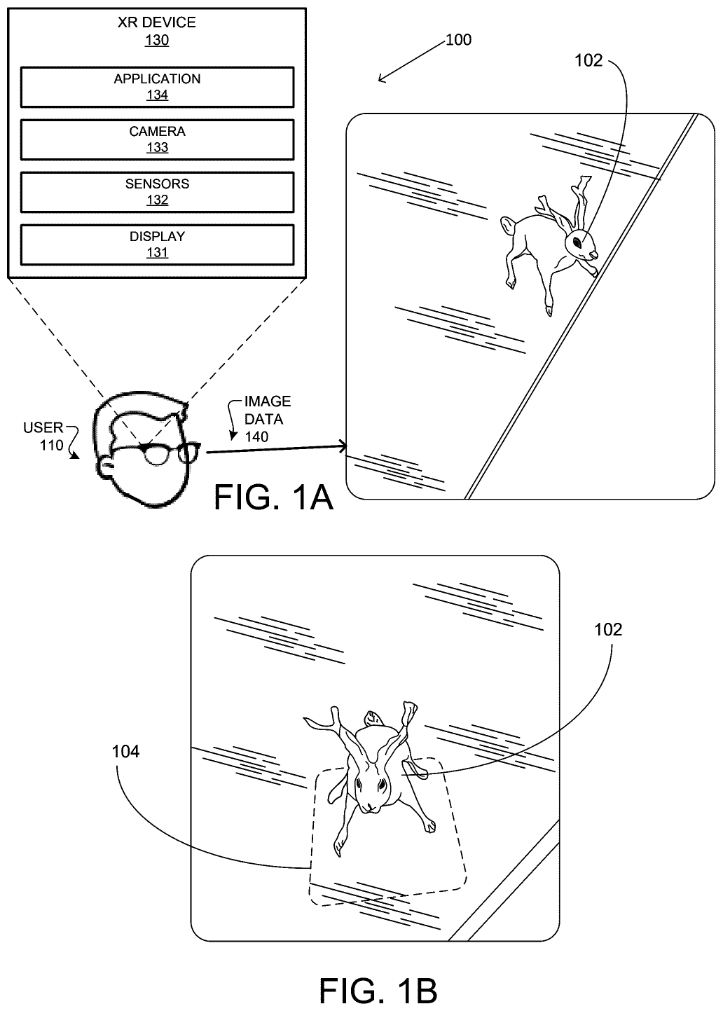

FIG. 1A shows an object 102 presented to a user 110 within an eXtended Reality (XR) environment. The object 102 is an example of a target. The view of the object 102 in FIG. 1A is from a perspective of the user 110. In the example shown in FIG. 1A, the object 102 is a physical object, a toy animal. The animal has a head of a rabbit, a body of a squirrel, antlers of a deer, and legs of a pheasant. The user 110 may have difficulty describing these features of the object 102.

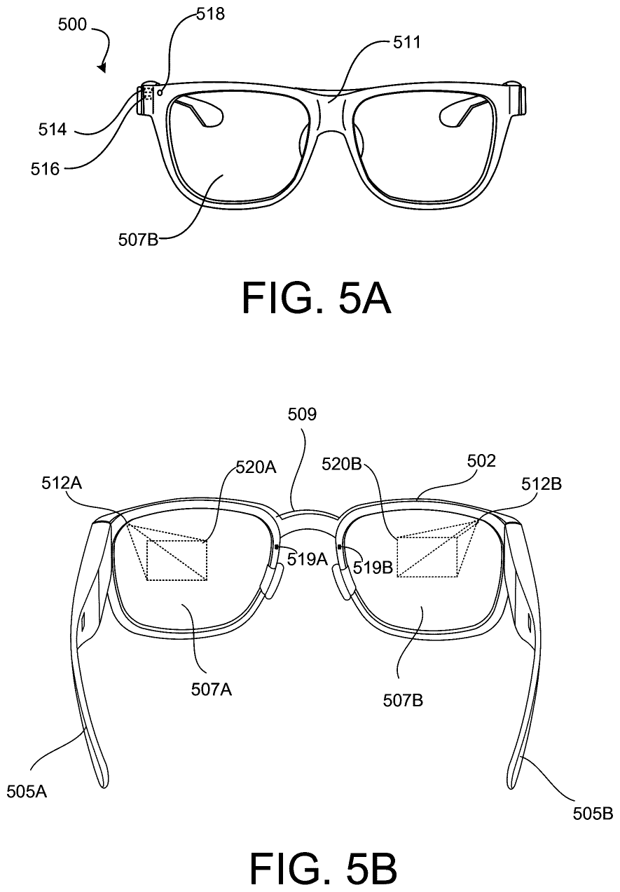

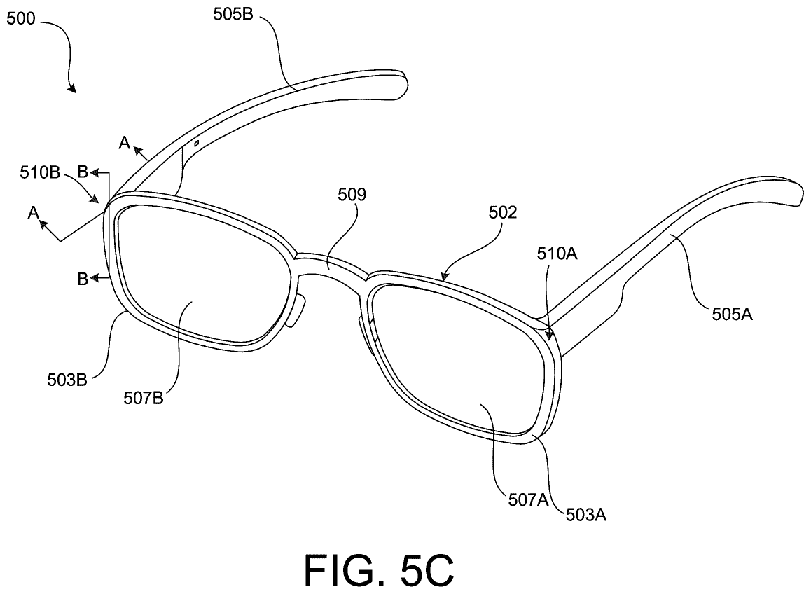

The XR environment can be generated and/or presented to the user 110 by an XR device 130 such as a wearable device, which can include smartglasses or XR goggles. An example of smartglasses is shown and described in more detail with respect to FIGS. 5A, 5B, and 5C. In some examples, the XR device 130 can present real-world, physical objects, including the object 102, through a transparent lens, and add information by superimposing images and/or graphics on the lens. In some examples, the XR device 130 can include a camera 133 that captures images of the physical environment and a display 131 that presents the physical environment, based on the captured images, to the user. The user 110 may desire to learn more about the object 102.

The XR environment can be part of a system 100 for managing application actions on a device according to an implementation. System 100 includes user 110, XR device 130, and image data 140. XR device 130 includes display 131, sensors 132, camera 133, and an application 134. Image data 140, which includes the object 102, can be captured using camera 133. Although demonstrated as an XR device 130 in the example of system 100, other wearable devices may perform similar functionality.

XR device 130 includes a combination of hardware and software components designed to create immersive virtual, augmented, or mixed reality experiences. Hardware elements include display 131, sensors 132, and camera 133. Display 131 may be a screen or projection system to present immersive visual experiences by rendering three-dimensional graphics and interactive content for visual output. Sensors 132 may include accelerometers and gyroscopes for tracking movement, microphones for capturing voice commands or other audio, depth sensors for spatial awareness and environment mapping, or some other type of sensor. Camera 133 may provide environment mapping, spatial tracking, and enabling augmented reality experiences for user 110. Camera 133 may represent an outward-facing camera that points away from the user 110, capturing the surrounding environment as seen by the user 110 to enable features such as augmented reality overlays, spatial mapping, and environment tracking.

Although demonstrated in the example of system 100 as providing content for display on XR device 130, similar operations can be performed to provide a variety of different actions. XR device 130 may use perspective information derived from cameras and/or infrared (IR) sensors to identify various information about the physical environment.

The information may include depth, distance, direction, size, or some other information associated with the physical environment. In some examples, the information is derived via API calls that identify supplemental information associated with the speech input from user 110.

FIG. 1B shows a selection of the object 102 presented in FIG. 1A. The user 110 can select the object 102 as a target for a query. The view of FIG. 1B is from a perspective of the user 110. The XR device 130 has selected the object 102 as the target. The XR device 130 may select the object 102 as the target in response to the user 110 prompting the XR device 130 to enter a search mode. The user 110 can prompt the XR device 130 to enter the search mode by a spoken command (such as “search”) or by a predetermined gesture (such as a pinching gesture), as non-limiting examples. The XR device 130 adds an indicator 104, which can be considered virtual content generated by the XR device 130, to the XR environment to indicate the selection of the object 102 as the target. The indicator 104 can be considered an indication of the target. The indication of the target can be considered one or more visual effects applied to or around a selected target to visually distinguish the selected target from other objects in a scene or field of view of the user. Such effects may include, but are not limited to, a surrounding shape, a color change, an animation, or an overlay. In the example shown in FIG. 1B, the indicator is a two-dimensional shape surrounding a base of the target, which is the object 102 in the example of FIG. 1B. In other examples, the indicator can include other visual elements used to differentiate or otherwise identify the selected target, such as changing a color of the selected target, changing a color of targets around the selected target, adding animation or animated elements (e.g., glimmers) near or around the target, or changing a color within the selected target or an icon within the selected target. In some examples, the indicator can include a two-dimensional screenshot that includes the object and surrounding environment that overlays the selected target.

In some examples, the XR device 130 determines the selection of the object as the target for the query based on a gaze of the user 110. The XR device 130 can determine the selection of the target based on the gaze of the user 110, for example by determining a location at which gazes of the eyes of the user 110 intersect and/or converge and determining what target (or object) appears at the location. In some examples, the XR device 130 determines the selection of the target based on the gaze of the user 110 remaining on the target for a threshold period of time. In some examples, the XR device 130 determines the selection of the target based on the gaze of the user 110 remaining on the target and a secondary input, such as the user 110 uttering a predetermined term or command such as “search” or providing a predetermined gesture, such as an eye gesture or hand gesture, or pressing a predetermined button that is included on the XR device 130. The XR device 130 may use segmentation techniques to determine which areas of the field of view represent potential targets (although segmentation does not identify what the target is, just that the target differs from background or other potential targets).

In some examples, the XR device 130, and/or a computing device in communication with the XR device 130, employs machine learning models to identify a target that is most likely to be selected by the user 110. The machine learning models can identify the target based on salient features of the target, types or categories of targets on the display, and/or a list of likely targets that intersect with a gaze of the user 110, as non-limiting examples. The machine learning models can weight or bias targets in a foreground (closer to the user) greater than targets in a background (farther from the user).

In some examples, the machine learning models select targets identified by a voice (or other textual input) of the user 110. The user 110 can, for example, request information about an “animal,” and the XR device 130 can, based on the request, submit a query for information about a target that includes the object 102 (which is a toy animal). In some examples, the user 110 requests information by voice, such as by asking, “Where does this animal live?,” or “Where can I buy this?” The XR device 130 can transcribe the voice or audio input into text and generate a query based on the text and the identified target. The query can include a multi-modal search request, including in the query either the voice or text input as well as the image that includes the identified target. In some implementations, the image that includes the target is generated as a two-dimensional snapshot, as disclosed herein. In some implementations, the query can be submitted to an application program interface of a search engine or other search service.

In an example in which the query requests general information about the identified target, the XR device 130 submits a query with a screenshot and/or a portion of the display 131 that includes the object 102. Excluding portions of the display 131 that do not include the object 102 protects privacy of the user 110 and other persons who may be within a field of view of the camera of the XR device 130 or be associated with targets within the field of view of the camera of the XR device 130.

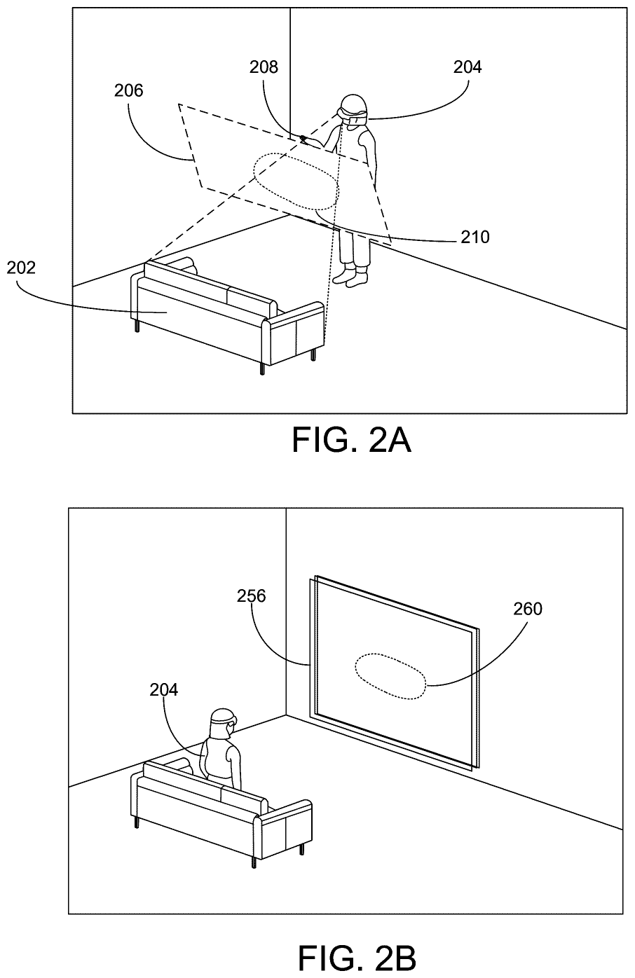

FIG. 2A shows a user 204 selecting a target 202 by movement of a hand 208 of the user 204. The user 204 is an example of the user 110 shown and described with respect to FIG. 1A. The user 204 can select the target for a query. In this example, the user 204 selects the target 202 by encircling the target 202 (or object) within a field of view of the user 204. In the example of a transparent lens through which the user 204 sees the target 202, the field of view can be an image captured by a camera included in the XR device 130 that captures images in a direction corresponding to a gaze of the user 204. In an example in which the XR device 130 captures images of the physical environment and presents images of the physical environment to the user 204 via a display included in the XR device 130, the field of view can include an image presented to the user 204 by the XR device 130, the image including the physical environment and virtual objects, text, and/or display elements added to the image by the XR device 130.

In an example in which the user 204 selects the target 202 by movement of the hand 208 of the user 204, the XR device 130 can generate a plane 206, or a portion of a plane 206. The plane 206 can be used to present an indication of the tracked movement of the hand 208. The plane 206 can be fully or partially transparent, enabling the user 204 to see objects that can be selected as targets, including the target 202, beyond the plane 206. The XR device 130 can superimpose the plane 206 and/or portion of the plane onto the physical environment. The XR device 130 can determine a depth of the plane 206, and/or a distance of the plane 206 from the user 204, based on contextual cues such as locations of objects within view of the user 204, gaze-tracking information such as an intersection of gazes of eyes of the user 204, and/or voice data indicating an object that the user 204 is focusing on. The user 204 can move the hand 208 (which can include a finger) of the user 204 in a shape 210 around the target 202 that the user 204 desires to select. The shape 210 can be circular, elliptic, or generally circular/elliptic. The shape 210 can be irregular. The shape 210 can be any two-dimensional shape. The XR device 130 can display an indication of the shape 210 on the plane 206.

The location on the plane 206 at which the XR device 130 displays the indication of the shape 210 can be a location on the plane 206 at which a ray extending from a portion of a head of the user 204 through a portion of the hand 208 of the user 204 intersects with and/or extends through the plane 206. The portion of the head of the user 204 can be a location of a camera included in the XR device 130. Displaying the location on the plane 206 based on the ray extending from the head through the hand 208 gives the user 204 the feeling of drawing with the hand 208 while reducing discontinuities of the shape 210 that would be caused by actually generating the shape based on the location of the hand 208. The plane 206 can maintain a constant depth, or distance from the user, of the shape 210 drawn by the user 204. The maintenance of the constant depth or distance by the plane 206 can compensate for a tendency of users to draw tilted circles (or other shapes) by moving their hands in and out when drawing a circle.

In some implementations, the XR device 130 can recognize a target within the shape 210 on the plane 206. As used herein, encircling the target 202 refers to enclosing the target 202 with the shape 210 regardless of whether the shape 210 is a circle or some other shape. In the example shown in FIG. 2A, the XR device 130 recognizes the target 202 as the target within the shape 210 selected by the user 204. In some implementations, the XR device 130 can recognize an area of the field of view as the target, the area being identified based on the shape 210. For example, the target may be defined as a two-dimensional snapshot generated by the XR device 130 using the techniques disclosed herein.

In some examples, the XR device 130 generates multiple planes along which the user 204 can draw a shape. The XR device 130 generates the multiple planes at locations based on windows presented by the XR device 130. Windows can include two-dimensional user interfaces. The planes generated by the XR device 130 can extend along and/or through the windows. While the hand 208 of the user 204 is drawing in a direction of a window generated by the XR device 130, the XR device 130 can set a depth of the drawing at and/or based on a depth of the plane corresponding to the window toward which the hand 208 of the user 204 is drawing. When the hand 208 is no longer pointing toward the window, the XR device 130 can initially maintain the depth of the drawing at and/or based on the depth of the plane corresponding to the window, but can adjust the depth while the hand 208 points away from the window. When the hand 208 points toward a different or new window, the XR device 130 can set the depth of the drawing at and/or based on a depth of a different or new plane corresponding to the different or now window. The XR device 130 can determine depth of the drawing between windows based on interpolation of the depths of the planes corresponding to the windows.

Encircling a target is an example of a technique for selecting a target (e.g., a physical object, virtual object, text, or display element). In some examples, selection of a target can be initiated by pressing a button (either a physical button or a soft button on a touchscreen) on the XR device 130. In some examples, selection of a target can be initiated by a gesture recognized by the XR device 130, such as pressing on a palm of a hand of a user. Initiation of selection of the target (such as by pressing a button or forming a gesture) can cause the XR device 130 to enter a target selection mode, during which time the XR device determines a location of the target. The location of the target can be identified based on hand movement or gaze direction of the user 204. In some examples, a target may be identified by framing the object with one's hands. For example, the framing of an area of the field of view may be recognized by the XR device 130 as selection of the area framed by the hands as the target. In this example, the target may be defined as a two-dimensional snapshot generated by the XR device 130 using the techniques disclosed herein. In some examples, selection of a target can be initiated by pinching fingers and pulling up.

In some examples, the XR device 130 selects a target based on a gaze of the user 204. The XR device 130 can segment and/or highlight candidate targets based on the gaze of the user 204, and the user 204 can select one of the candidate targets by a gesture such as pinching in a location associated with the candidate target. In some examples, the XR device 130 selects a target by detecting a gaze of the user 204 toward a target, presenting a shape (e.g., an oval, a circle, a rectangle), also referred to as an indication, centered at the location of the gaze of the user 204, and changing a size of the shape in response to pinching and dragging gestures of the user 204. The XR device 130 may select a target with minimal depth (or distance from the user 204) within the encircled area. In some examples, the XR device 130 selects a target based on movement of a finger of the user 204 in which the user 204 implements the finger as a virtual stylus. In some examples, the XR device 130 selects a target based on gestures of both hands of the user 204 encircling the target or framing the object with hands of the user 204.

FIG. 2B shows a display 256 presenting a selection 260 by a user 204. While not shown in FIG. 2B, the display 256 may have presented an XR environment including a target. The user 204 may have moved a hand of the user 204 in an oval shape corresponding to the selection 260. The selection 260 can encircle a target. The XR device 130 can recognize the encircled target as the target selected by the user 204.

In some examples, the XR device 130 generates a two-dimensional image based on the target. The two-dimensional image can be considered a digital representation, such as a screenshot or snapshot, of a user-selected portion of a three-dimensional scene, wherein the image captures both physical objects from the real-world environment and virtual objects generated by an extended reality device. The two-dimensional image may be used as part of a query to a search engine. The screenshot can be a two-dimensional image that corresponds to a portion of the three-dimensional scene as viewed by the user 204. The three-dimensional scene can be considered a field of view of a user within an extended reality environment, and can include a combination of physical objects from a real-world environment and computer-generated virtual objects. The screenshot can include physical and virtual objects viewed by the user 204 within the XR environment. The screenshot can be a portion of a field of view selected by the user 204, i.e., the target. The XR device 130 can generate the screenshot based on one or more cameras capturing one or more images from a perspective of the user 204 and adding AR content to the image(s). The user 204 can select the portion of the field of view by, for example, a hand or finger motion that selects the portion of the field of view. The user 204 can use any gestures that provide a width and height (e.g., encircling, drawing an x, using the hands as a frame, etc.) for the portion, i.e., the selected target. In some examples, the XR device 130 generates a target area that is a rectangle with a width and height based on a width and height of the motion performed by the hand or finger of the user 204. A target area can be a specific region of a field of view of the user selected by input of the user, such as a hand gesture. The extended reality (XR) device can generate the target area, which may be a rectangle or other shape, to identify the specific content that will form the basis of a two-dimensional image for a query. In some examples, the XR device 130 generates the target area in a shape other than a rectangle. The XR device 130 may generate the target area in the shape other than the rectangle to exclude protected content. The content may be protected for privacy reasons. In such examples, the shape may be irregular to exclude an object determined to include protected (e.g., private) information that would otherwise be within the rectangle. In some implementations, the XR device 130 may exclude content in a portion of the shape that is determined to encompass protected content (e.g., private information). For example, the XR device 130 may apply a monochrome color to (e.g., black out or white out) or blur an area that includes an object that should not be included in the target area because it represents protected content. In some examples, the XR device 130 generates a target volume or space in three dimensions. In some examples, the XR device 130 initiates recognizing an encircling motion as selecting a screenshot in response to a command, such as a voice command, a predetermined gesture (such as a pinching gesture), or predetermined eye movement.

The XR device 130 can present the screenshot to the user 204 as a virtual object. The XR device 130 can present the screenshot to the user 204 in a location that overlays, and/or appears to be in front of, physical objects within the screenshot, similar to plane 206. The XR device 130 can present the screenshot to the user 204 as extending along a plane that is perpendicular to a ray extending from the user 204 to the screenshot. The XR device 130 can present the screenshot to the user 204 in a farthest location from the user 204 that does not intersect with any virtual or physical objects of the XR environment. The XR device 130 can determine the distance from the user 204 that is farthest from the user 204 but does not intersect with any virtual or physical objects by determining distances of multiple rays. The rays extend from the user 204 toward the target, e.g., the portion of the XR environment that corresponds with motion of the user 204 that selects the portion of the field of view. The distances can be distances from the user 204 or XR device 130 to a virtual or physical object in the portion of the field of view that corresponds to the screenshot. The XR device 130 can select the shortest distance of the distances of the rays. In some implementations, the XR device 130 can select a shortest ray from the user 204 to the virtual or physical object. A shortest ray can be a shortest calculated distance among a plurality of rays cast from the perspective of the user 204 to various points on surfaces of objects within the target area. The shortest ray can identify the object closest to the user 204 within that target area and is used to establish a reference depth for placing new virtual content, such as a two-dimensional image. The XR device 130 can present the two-dimensional image at a location based on the shortest ray from the user 204 to the object in the three-dimensional scene represented by the target. The XR device 130 can present the screenshot at a location that is based on the selected shortest distance from the user 204. For example, the XR device 130 can select a location that is a predetermined distance from the location represented by the shortest distance. This predetermined distance may ensure that the screenshot object is in front of the virtual and physical objects in the portion of the field of view, so that the screenshot object does not extend through any of the virtual and physical objects on the portion of the field of view.

In some examples, the XR device 130 determines whether a size of the screenshot object exceeds a threshold size. The threshold size is a system-defined parameter and can be a size of a file that represents the image. If the XR device 130 determines that the size of the screenshot object exceeds the threshold size, then the XR device 130 can downscale the image so that a size of the screenshot object is less than or equal to the threshold size. Downscaling can be an operation performed on a two-dimensional image to modify and/or reduce a size of a file that represents the two-dimensional image. Downscaling can ensure the file representing resulting virtual object and/or screenshot can be transmitted to a search engine.

The XR device 130 can present the screenshot object to the user 204 with a fixed orientation with respect to the user 204. The fixed orientation can be considered a display property of a virtual object wherein an orientation of the virtual object remains constant relative to a viewpoint of the user, such that an apparent angle of the virtual object does not change as the head of the user moves or rotates, in contrast to other objects within the three-dimensional scene for which an angle and/or location within a virtual scene does change as the head of the user moves or rotates. When the user 204 moves and/or rotates a head of the user 204, perspectives of physical and/or virtual objects will change based on the movement and/or rotation. The fixed orientation of the screenshot object with respect to the user 204 can indicate to the user 204 that the screenshot object is the target that will be the basis of a search and/or query. In some examples, the XR device 130 can rotate the screenshot object about a horizontal axis to prevent the screenshot object from overlapping with physical objects or virtual objects. Rotation of the screenshot object about the horizontal axis maintains the fixed horizontal orientation of the screenshot object with respect to the user 204, indicating to the user 204 that the screenshot object is a screenshot that will be the basis of a search and/or query. The user 204 can indicate confirmation of a search and/or query based on the screenshot, such as by a predetermined spoken command and/or predetermined gesture. A confirmation can be a predefined user input, such as a gesture or command, received after a target has been identified. The confirmation can authorize the XR device 130 to proceed with a query based on the target. The XR device 130 can respond to the indication of confirmation by performing a query and/or search based on the screenshot.

In some examples, the XR device 130 submits a query by sending an image based on the portion of the display associated with the shape 210. The XR device 130 can exclude protected information, such as by excluding a portion of the three-dimensional scene that is determined to include protected information. Protected information can be considered any data within a field of view of the user that is identified by the user and/or the XR device 130 as sensitive for privacy reasons and is therefore excluded from a query. Protected information, or sensitive information, can include passwords, financial information, or faces of persons who may not want their pictures to be shared. Excluding portions of the display that are not associated with the shape 210 protects privacy of the user and other persons who may have sensitive information within the field of view of a camera of the XR device. In some examples, the XR device 130 submits a query by sending an image in a shape of a rectangle (or other shape) that includes the shape 210. In some examples, the XR device 130 submits the query by sending multiple images and/or a video based on the portion of the display associated with the shape 210.

The query and/or search can be based on an object and/or target within the screenshot. The XR device 130, and/or a computing device in communication with the XR device 130 to which the XR device 130 sends the screenshot, can determine the target within the screenshot. The target within the screenshot can be determined based on an object that is centered within the screenshot, an object with salient features within the screenshot, and/or based on an eye gaze of the user 204 toward an object within the screenshot.

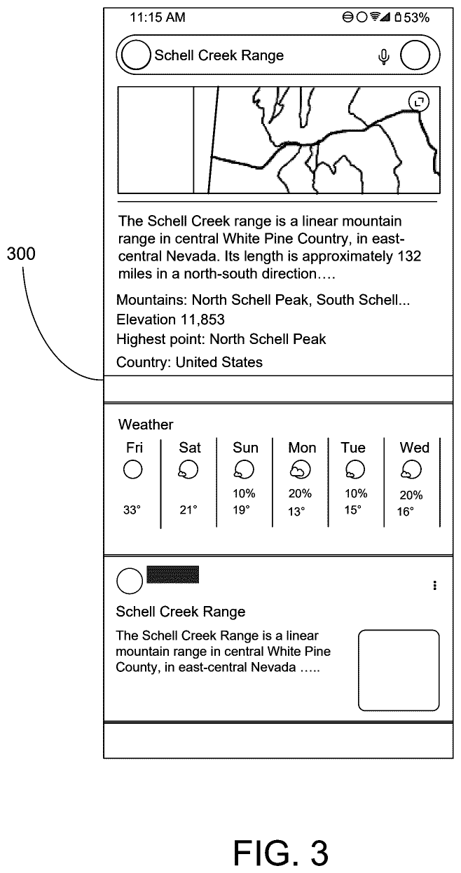

FIG. 3 shows a presentation of search results 300 in response to selection of a target. The user may have selected the target. FIG. 3 is an example of a tile that the XR device 130 can add to an XR environment presented to a user. The target may have been selected by any means, such as the selections shown in FIGS. 1B, 2A, or 2B. The XR device 130 responds to the suggestion by generating a query using the selected target. In some examples, the XR device 130 generates the query by submitting a description of the selected target to a search engine. In some examples, the XR device 130 generates the query based on both a transcription of the voice input received from the user and the selected target. In some examples, the XR device 130 confirms that the user desires a query to be performed based on hand movement or voice input of the user (such as a predetermined word or command such as “search”). In some examples, the XR device 130 determines that the user desires a query to be performed based on a predetermined structure identified in voice input from the user. The predetermined structure may represent a question (interrogatory) structure. In some implementations, the XR device 130 may classify the voice input as having the predetermined structure. The XR device 130 may generate the query from the voice input when the voice input matches the predetermined structure. The search results 300 are search results that the XR device 130 received in response to the query that the XR device 130 submitted to the search engine.

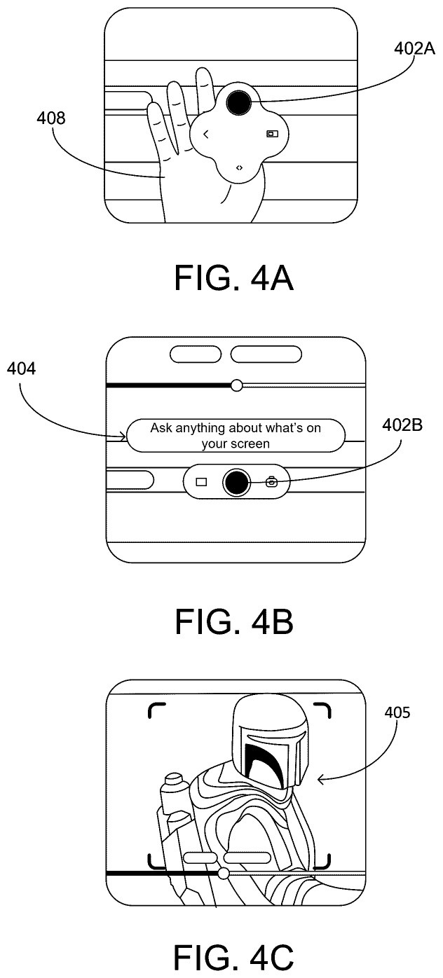

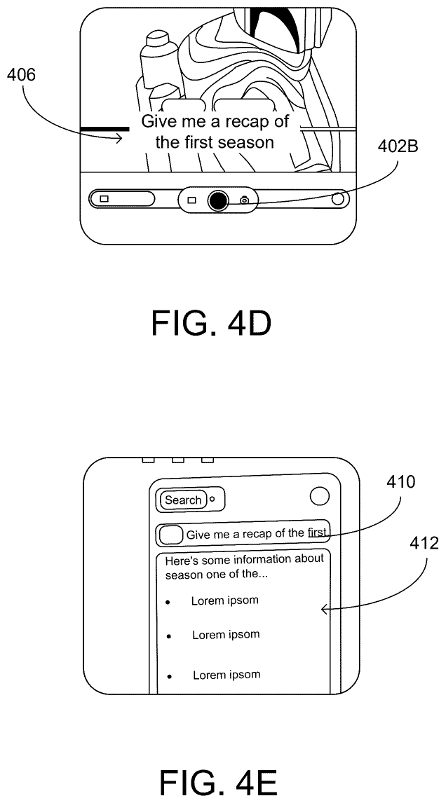

FIG. 4A shows a selection of a query icon 402A that can be used in some implementations. The XR device 130 presents a virtual hand 408 to the user via a display included in the XR device 130. The virtual hand 408 corresponds to a hand of the user captured by a camera included in the XR device 130. The XR device 130 presents a query icon 402A via the display. The user can move the hand of the user, and the XR device 130 will move the virtual hand 408 to correspond to movements of the hand of the user. The user can move a finger included in the hand of the user to cause a finger of the virtual hand 408 to tap on or otherwise select the query icon 402A. The XR device 130 can perform a query, and/or enter a query mode, in response to the finger of the virtual hand 408 selecting the query icon 402A. In some implementations, the XR device 130 can enter a query mode in response to a predetermined command.

FIG. 4B shows a prompt 404 to request a query. The prompt 404 includes text prompting the user to request a query. In the example shown in FIG. 4B, the text included in the prompt 404 is, “Ask anything about what's on your screen.” The display can also include a query icon 402B. The XR device 130 can respond to selection of the query icon 402B by performing a query and/or entering a query mode in a similar manner as described with respect to FIG. 4A or a predetermined command.

FIG. 4C shows a partial view of a three-dimensional environment with a target 405 for selection. In the example shown in FIG. 4C, the target 405 is bounded by the four curved corners shown in FIG. 4C. The user can select the target 405 for a query. The target 405 can be a two-dimensional image generated by the XR device 130. The two-dimensional image can be presented to the user via a display included in the XR device 130. The XR device 130 may have entered a query mode in response to the user selecting the query icon 402A or the query icon 402B. The user can initiate a query for the target 405 using a predetermined gesture or command, including gaze-based gestures, tapping gestures, hand gestures, selection of physical affordances such as buttons, selection of virtual affordances such as virtual buttons or other controls, or a predetermined voice command, as non-limiting examples.

FIG. 4D shows a partial view of a three-dimensional environment with a transcription of a text to be used in a query. In this example, the user has provided voice input transcribed into text 406 and requested a query by selecting the query icon 402B. The XR device 130 generates a query based on the transcribed text 406 and the target, e.g., target 405 of FIG. 4C. The query can describe the selected target or an object or entity associated with the target. In this example, the target includes an image from a television series, and the query supplements the text 406 (“give me a recap of the first season”) based on the target (which relates to a television series) selected in FIG. 4C, resulting in, “give me a recap of the first season [of the television series].”

FIG. 4E shows a response 412 to the query that includes the text 406 of FIG. 4D and the target 405 of FIG. 4C. The response 412 includes text describing a first season of a television series. The display also presents a portion 410 of the text 406 of the query to assist the user in determining what the response 412 is responsive to.

FIGS. 5A, 5B, and 5C show an example of an XR device 500. The XR device 500 is an example of the XR device 130. As shown in FIGS. 5A, 5B, and 5C, the example XR device 500 includes a frame 502. The frame 502 includes a front frame portion defined by rim portions 503A, 503B surrounding respective optical portions in the form of lenses 507A, 507B, with a bridge portion 509 connecting the rim portions 503A, 503B. Arm portions 505A, 505B are coupled, for example, pivotably or rotatably coupled, to the front frame by hinge portions 510A, 510B at the respective rim portion 503A, 503B. In some examples, the lenses 507A, 507B may be corrective/prescription lenses. In some examples, the lenses 507A, 507B may be an optical material including glass and/or plastic portions that do not necessarily incorporate corrective/prescription parameters. Displays 512A, 512B (which can present the plane 206, shape 210, search results 300, or any of the images presented in FIGS. 4A through 4E) may be coupled in a portion of the frame 502. In the example shown in FIG. 5B, the displays 512A, 512B are coupled in the arm portions 505A, 505B and/or rim portions 503A, 503B of the frame 502. In some examples, the XR device 500 can also include an audio output device 516 (such as, for example, one or more speakers), an illumination device 518, at least one processor 511, an outward-facing image sensor 514 (or camera), and gaze-tracking cameras 519A, 519B that can capture images of eyes of the user 204 to track a gaze of the user 204. In some examples, the XR device 500 may include a see-through near-eye display. The processor 511 can include a non-transitory computer-readable storage medium comprising instructions thereon that, when executed by the at least one processor 511, cause the XR device 500 to perform any combination of methods, functions, and/or techniques described herein. For example, the displays 512A, 512B may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 507A, 507B, next to content (for example, digital images, user interface elements, virtual content, and the like) generated by the displays 512A, 512B. In some implementations, waveguide optics may be used to depict content on the displays 512A, 512B via outcoupled light 520A, 520B. The images projected by the displays 512A, 512B onto the lenses 507A, 507B may be translucent, allowing the user 204 to see the images projected by the displays 512A, 512B as well as physical objects beyond the XR device 500.

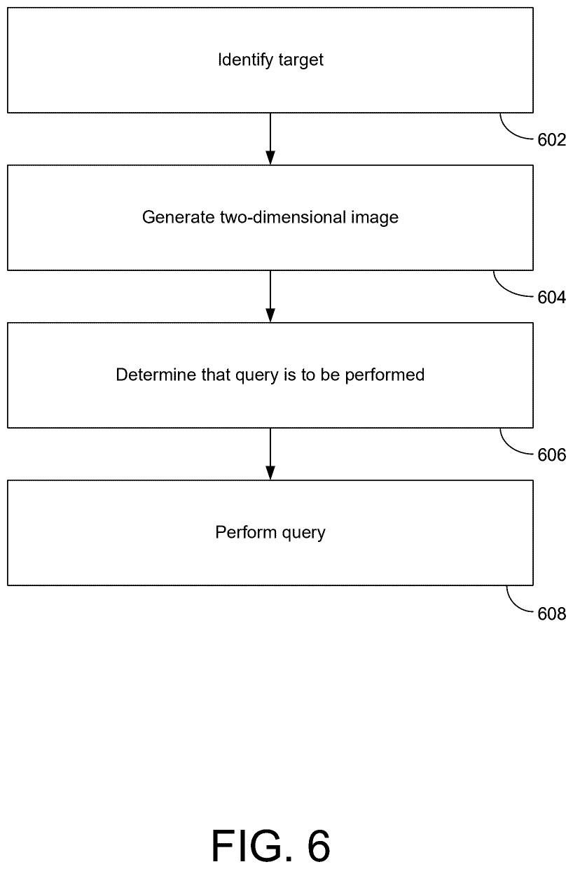

FIG. 6 is a flowchart of a method. The method can include identifying a target (602). Identifying the target (602) can include identifying the target within a three-dimensional scene based on input from a user. The method can include generating a two-dimensional image (604). Generating the two-dimensional image (604) can include generating the two-dimensional image based on the target. The method can include determining that a query is to be performed (606). Determining that the query is to be performed (606) can include determining that a query based on the two-dimensional image is to be performed. The method can include performing the query (608). Performing the query (608) can include performing the query based on the two-dimensional image.

In some implementations, the method further includes presenting the two-dimensional image to the user with a fixed orientation within the three-dimensional scene.

In some implementations, the two-dimensional image is presented at a location based on a shortest ray from the user to an object in the three-dimensional scene represented by the target.

In some implementations, the two-dimensional image excludes a portion of the three-dimensional scene determined to include protected information.

In some implementations, the method further includes determining that a size of the two-dimensional image exceeds a threshold size; and based on the size of the two-dimensional image exceeding the threshold size, downscaling the two-dimensional image to a size less than or equal to the threshold size.

In some implementations, the method further includes presenting an indication of the target in response to identifying the target.

In some implementations, the method further includes presenting the two-dimensional image to the user with a fixed orientation with respect to the user. Determining that the query based on the target is to be performed can include receiving, from the user, a confirmation of the two-dimensional image as the target.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a non-transitory machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the described implementations.

What is claimed is:

1. A method comprising:
identifying a target within a three-dimensional scene based on input from a user;
generating a two-dimensional image based on the target;
determining that a query based on the two-dimensional image is to be performed; and
performing the query based on the two-dimensional image.

2. The method of claim 1, further comprising presenting the two-dimensional image to the user with a fixed orientation within the three-dimensional scene.

3. The method of claim 1, wherein the two-dimensional image is presented at a location based on a shortest ray from the user to an object in the three-dimensional scene represented by the target.

4. The method of claim 1, wherein the two-dimensional image excludes a portion of the three-dimensional scene determined to include protected information.

5. The method of claim 1, further comprising:
determining that a size of the two-dimensional image exceeds a threshold size; and
based on the size of the two-dimensional image exceeding the threshold size, downscaling the two-dimensional image to a size less than or equal to the threshold size.

6. The method of claim 1, further comprising presenting an indication of the target in response to identifying the target.

7. The method of claim 1, further comprising:
presenting the two-dimensional image to the user with a fixed orientation with respect to the user,
wherein determining that the query based on the target is to be performed includes receiving, from the user, a confirmation of the two-dimensional image as the target.

8. A non-transitory computer-readable storage medium comprising instructions stored thereon that, when executed by at least one processor, are configured to cause a computing system to:
identify a target within a three-dimensional scene based on input from a user;
generate a two-dimensional image based on the target;
determine that a query based on the two-dimensional image is to be performed; and
perform the query based on the two-dimensional image.

9. The non-transitory computer-readable storage medium of claim 8, wherein the instructions are further configured to cause the computing system to present the two-dimensional image to the user with a fixed orientation within the three-dimensional scene.

10. The non-transitory computer-readable storage medium of claim 8, wherein the two-dimensional image is presented at a location based on a shortest ray from the user to an object in the three-dimensional scene represented by the target.

11. The non-transitory computer-readable storage medium of claim 8, wherein the two-dimensional image excludes a portion of the three-dimensional scene determined to include protected information.

12. The non-transitory computer-readable storage medium of claim 8, wherein the instructions are further configured to cause the computing system to:
determine that a size of the two-dimensional image exceeds a threshold size; and
based on the size of the two-dimensional image exceeding the threshold size, downscale the two-dimensional image to a size less than or equal to the threshold size.

13. The non-transitory computer-readable storage medium of claim 8, wherein the instructions are further configured to cause the computing system to present an indication of the target in response to identifying the target.

14. The non-transitory computer-readable storage medium of claim 8, wherein the instructions are further configured to cause the computing system to:
present the two-dimensional image to the user with a fixed orientation with respect to the user,
wherein determining that the query based on the target is to be performed includes receiving, from the user, a confirmation of the two-dimensional image as the target.

15. A computing system comprising:
at least one processor; and
a non-transitory computer-readable storage medium comprising instructions stored thereon that, when executed by the at least one processor, are configured to cause the computing system to:
identify a target within a three-dimensional scene based on input from a user;
generate a two-dimensional image based on the target;
determine that a query based on the two-dimensional image is to be performed; and
perform the query based on the two-dimensional image.

16. The computing system of claim 15, wherein the instructions are further configured to cause the computing system to present the two-dimensional image to the user with a fixed orientation within the three-dimensional scene.

17. The computing system of claim 15, wherein the two-dimensional image is presented at a location based on a shortest ray from the user to an object in the three-dimensional scene represented by the target.

18. The computing system of claim 15, wherein the two-dimensional image excludes a portion of the three-dimensional scene determined to include protected information.

19. The computing system of claim 15, wherein the instructions are further configured to cause the computing system to:
determine that a size of the two-dimensional image exceeds a threshold size; and
based on the size of the two-dimensional image exceeding the threshold size, downscale the two-dimensional image to a size less than or equal to the threshold size.

20. The computing system of claim 15, wherein the instructions are further configured to cause the computing system to present an indication of the target in response to identifying the target.
